(19) United States
(12) Patent Application Publication
(10) Pub. No.: US 2003/0054696 A1
(43) Pub. Date: Mar. 20, 2003

(54) IMPROVED POWER SOURCE CONNECTOR ASSEMBLY FOR AN EXTRACTABLE HARD DRIVE BOX

(76) Inventors: Cheng-Tzu Peng, Chupei City (TW); Chuan-Yi Yeh, Hsinchu City (TW)

Correspondence Address: RABIN & BERDO, P.C., Suite 500, 1101 14 Street, N.W., Washington, DC, 20005, US

(21) Appl. No.: 10/197,897

(22) Filed: Jul. 19, 2002

Related U.S. Application Data
(63) Continuation-in-part of application No. 09/953,274, filed on Sep. 17, 2001, now abandoned.

(51) Int. Cl. H01R 25/00

(52) U.S. Cl. 439/640

(57) ABSTRACT

A power source connecting holder for hard disc extraction box includes a plastic block set on the power source connecting holder, a slide track slot disposed between the plastic block and the power source connecting holder, a fillister set on the top side of the plastic block, a spring leaf set on the upper edge of inner wall of the fillister, and a convex block set at one end of the spring leaf. The power source connecting holder is installed on the back side of a connector support with a slide track and a positioning slot, the convex block of the spring leaf on the power source connecting holder will insert in the positioning slot of the connector support, and the power source connecting holder can be slidable and adjustable in response to the different positions of the power source connector of hard disc.

This application is a Continuation-In-Part of patent application, Serial No. 09/953,274, filed on Sep. 17, 2001.

### BACKGROUND OF THE INVENTION

The present invention is related to an improved power source connecting holder for hard disc extraction box wherein the power source connecting holder is adjustable in response to the different positions of the power source connector of the hard disc.

The conventional hard disc extraction boxes now on sale and in use have the following drawbacks:

Since the hard discs made by various manufacturers are different from each other, and the difference consists in the position where the power source connector of hard disc is disposed but the power source connecting holder of hard disc extraction box cannot be adjustable in full response to the different hard discs.

In view of the foregoing drawbacks, the present inventor developed the present invention in the light of his experiences in designing the products concerned.

### SUMMARY OF THE INVENTION

The primary object of present invention is to offer an improved power source connecting holder for hard disc extraction box wherein the power source connecting holder can be desirably adjustable in response to the different positions of power source connector of the hard disc.

### BRIEF DESCRIPTION OF THE DRAWINGS

The primary object, characteristics and functions of the present invention can best described in conjunction with the following drawings:

FIG. 1 is an appearance view of the present invention.

FIG. 2 is a breakdown view of the present invention and soft bank wire.

FIG. 3 is an assembly view of the present invention and soft bank wire.

FIG. 4 is a breakdown view of the present invention and connector support assembly.

FIG. 5 is an assembly view of the present invention and connector support assembly.

FIG. 6 is a front section view of the connector support of the present invention.

### DETAILED DESCRIPTION OF PREFERRED J.EMBODIMENT

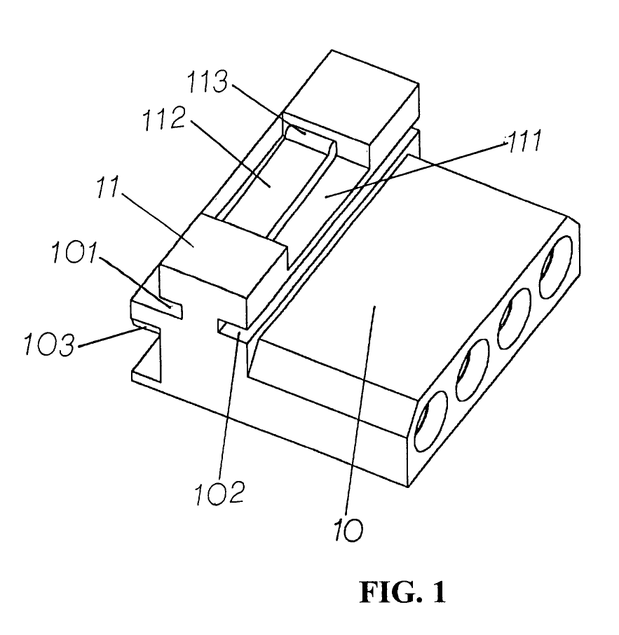

As shown in FIG. 1, a plastic block (11) is set on a power source connecting holder (10), two slide track slots (101), (102) are disposed between the power source connecting holder (10) and the plastic block (11), a fillister (111) is set on the top side of the plastic block (11), a spring leaf (112) is disposed on the upper edge of an inner wall of the fillister (111); the spring leaf (112) with elasticity is made of plastic, and a convex block (113) is set at one end of the spring leaf (112); the convex block (113) is in the shape of a semi-circular are and can be inserted in two positioning slots (204a, 204b) so as to fix the power source connecting holder (10) which will not slide therefore.

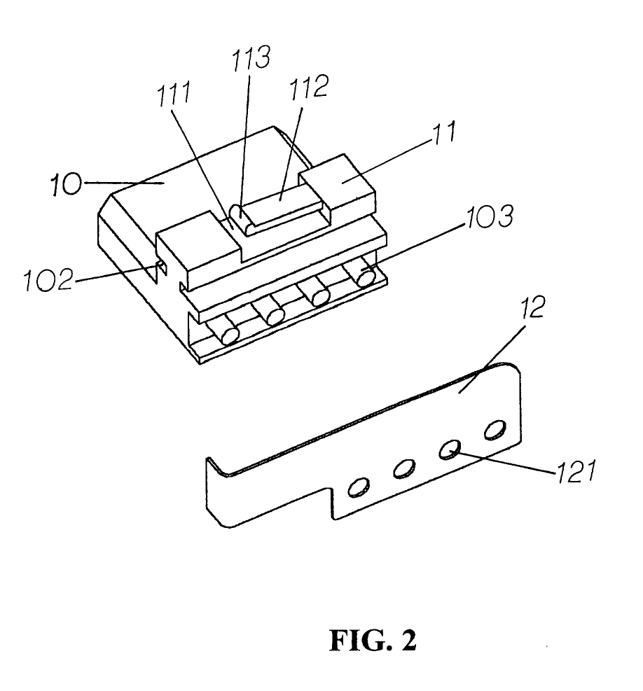

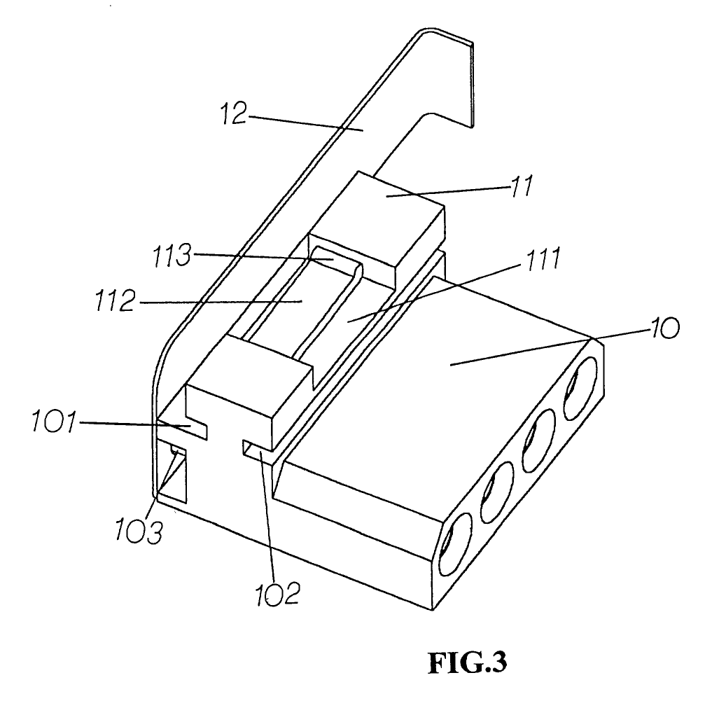

As shown in FIGS. 2 and 3, a soft bank wire (12) substitutes for the conventional power source transmission line for current transmission, and four connecting holes (121) are set on the soft bank wire (12) for connecting a connecting leg (103) of the power source connecting holder (10).

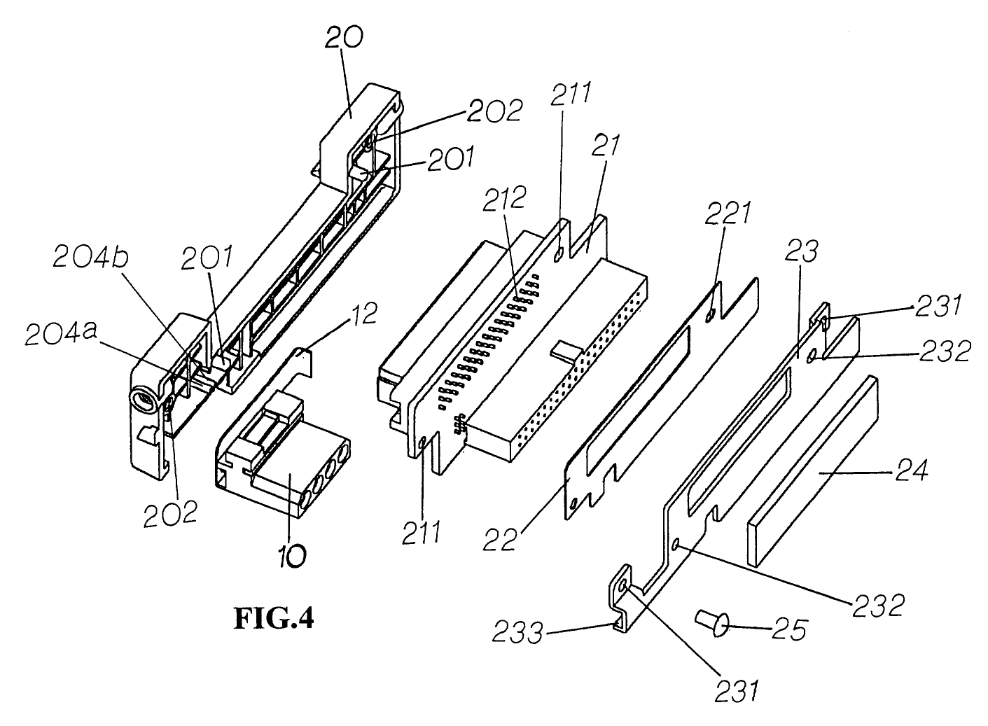

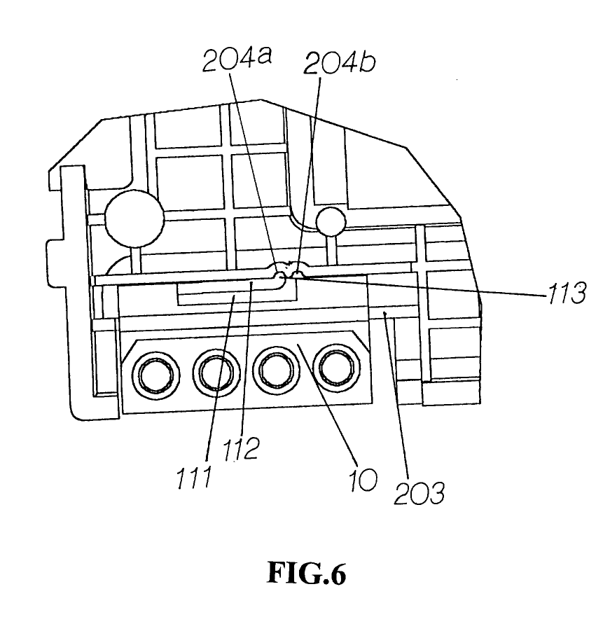

As shown in FIG. 4 and 6, a fixing bolt (201), a screw hole (202), a slide track (203) and two positioning slots (204a, 204b) are disposed on the back side of a connector support (20); the fixing bolt (201) is designed to fix an article with a bolt hole to be applied over the fixing bolt (201); the screw hole (202) is designed to lock a screw (25) and to insert the slide track (203) in the slide track slot (101) of the power source connecting holder (10) which can slide therein; the positioning slots (204a, 204b) are disposed on the top side of slide track (203) so as to catch the convex block (113) in place.

As shown in FIG. 4, one each bolt hole (211) is disposed on the left and right sides of the panel of a printed circuit board component (21) to be applied over the fixing bolt (201) which will not move therefore; and similarly, one each bolt hole (221) is disposed on the left and right sides of an insulating piece (22) to be applied over the fixing bolt (201) so as to fix the insulating piece (22) on the connector support (20). One each screw hole (231) and one each bolt hole (232) are disposed on the left and right sides of a metal fixing piece (23), and a slide track (233) is disposed below the screw hole (231) which is designed to lock a screw (25) and further to fix the metal fixing piece (23) whereon the bolt hole (232) is applied over the fixing bolt (201) so as to fix the metal fixing piece (23) on the connector support (20); the slide track (233) on the metal fixing piece (23) is to be inserted in the slide track slot (102) of power source connecting holder (10) which can slide on the slide track (233). A pin leg protecting cover (24) is designed to protect a pin leg (212) on the printed circuit board component (21) so as to avoid the pin leg (212) from suffering damage or to avoid the user from suffering hurt by the pin leg (212).

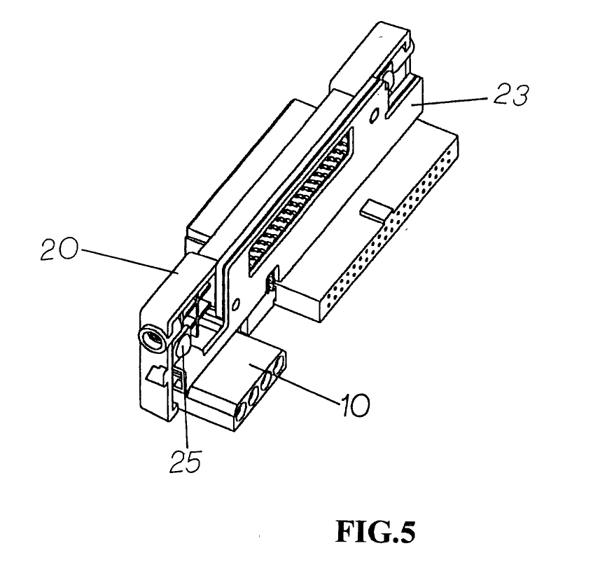

As shown in FIGS. 4 to 6, let the slide track slot (101) of power source connecting holder (10) correspond to the slide track (203) on the connector support (20) so as to insert the slide track (203) in the slide track slot (101) and install the power source connecting holder (10) on the connector support (20); next, the printed circuit board component (21) and insulating piece (22) are applied over the fixing bolt (201) on the connector support (20) by means of the bolt holes (211,221) in sequence and then overlapped on and connected to the connector support (20). The screw hole (231) and bolt hole (232) on the metal fixing piece (23) correspond to the fixing bolt (201) and screw hole (202) of connector support (20) and then overlap on and connect to the insulating piece (22), the slide track (233) of metal fixing piece (23) will insert in the slide track slot (102) of power source connecting holder (10). Then let two screws (25) correspond to the screw holes (231) of metal fixing piece (23) respectively and lock in the screw holes (231) of metal fixing piece (23) so as to tightly fix the printed circuit board component (21) and insulating piece (22).

As shown in FIGS. 3 and 4 after the power source connecting holder (10) and the connector support (20) assemble with each other, the connecting hole (121) of soft bank wire (12) is connected to the connecting leg (103) of power source connecting holder (10).

As shown in FIG. 6, when the power source connecting holder (10) slides rightward, the convex block (113) and the inner wall of positioning slot (204a) will squeeze each other, the spring leaf (112) will bend toward the bottom of fillister (111), the power source connecting holder (10) will slide rightward; and when the convex block (113) moves from one positioning slot (204a) to another positioning slot (204b), the spring leaf (112) will restore its own original state because of its own elasticity, and the convex block (113) will insert in the positioning slot (204b).

I claim:

1. An improved power source connecting holder for hard disc extraction box, which is characterized in the following:
a plastic block is set on the power source connecting holder, a slide track slot is disposed between the plastic block and power source connecting holder, a fillister is set on the top side of plastic block, a spring leaf is set on the upper edge on the inner wall of the fillister, and a convex block is set on the spring leaf;
the connecting holder is disposed on a connector support with a slide track and a positioning slot so as to insert the slide track of the support in the slide track slot of the connecting holder, and the convex block on the spring leaf of the connecting holder will insert in the positioning slot; and then a printed circuit board component, an insulating piece, a metal fixing piece and a pin leg protecting cover in sequence are overlapped on and connected to the back side of the connector support and fixed by means of screws.
